(19) United States
(12) Patent Application Publication
(10) Pub. No.: US 2025/0042241 A1
(43) Pub. Date: Feb. 6, 2025

(54) ELECTRICALLY POWERED VEHICLE AND DRIVETRAIN

(71) Applicant: HYZON MOTORS USA INC., Bolingbrook, IL (US)

(72) Inventors: Qunlong Dong, Ellicott City, MD (US); George Gu, Naperville, IL (US)

(21) Appl. No.: 18/721,758

(22) PCT Filed: Dec. 22, 2022
(86) PCT No.: PCT/US2022/053832

§ 371 Date: Jun. 19, 2024

Related U.S. Application Data
(60) Provisional application No. 63/293,705, filed on Dec. 24, 2021.

(51) Int. Cl. B60K 7/00; B60K 1/02; B60K 17/02

(52) U.S. Cl. CPC B60K 7/0007; B60K 1/02; B60K 17/02; B60K 2007/0092

(57) ABSTRACT

An electric vehicle may comprise a chassis extending between a front and a rear and having a steering axle coupled to the chassis and arranged near the front. The electric vehicle may further comprise a first drive axle and a second drive axle coupled to the vehicle chassis and arranged near the rear. The first drive axle may comprise a first axle housing, a first drive wheel rotatably supported by the first axle housing, and a first electric machine operably coupled to the first drive wheel through a first power path, the first power path including a first gear reduction. The second drive axle may comprise a second axle housing, a second drive wheel rotatably supported by the second axle housing, and a second electric machine operably coupled to the second drive wheel through a second power path, the second power path having no speed change.

### CROSS-REFERENCE TO RELATED APPLICATIONS

The subject patent application claims priority to, and all the benefits of, U.S. Provisional Patent Application No. 63/293,705, filed on Dec. 24, 2021, the entire contents of which are incorporated by reference herein.

### BACKGROUND

Unlike vehicles powered by traditional internal combustion engines where energy conversion efficiency may increase with load levels and thus specific energy consumption, measured in mile/gallon or in gram/kWh, generally deteriorates less significantly with driveline losses since the losses increase the engines' load levels. Electric vehicles, including hybrid electric vehicles, battery electric vehicles (BEV), and fuel cell electric vehicles, tend to have specific energy consumptions more sensitive to driveline losses because electric motors have very low losses across most of their operation range. Reducing driveline losses becomes more effective in increasing electric vehicles' drive ranges or cutting the costs of their energy storage systems if ranges are to be maintained the same.

Various efforts have been implemented to minimize the driveline loss for electric vehicles. Using 2 speed or multiple speed transmission to keep the operating points in the high efficiency zoom of the electric motors is a widely used approach with approved effectiveness. However, due to the losses from additional gear meshing and oil stirring from additional gears, the effectiveness in overall loss reduction tends to be quite limited. Another direction is to use in-wheel motors by eliminating the gear meshing and oil stirring losses. To fulfill the needs of launch-ability and grade-ability of vehicles, the motors tend to be heavy and expensive due to their high usage of rare earth magnets and other raw materials.

It is highly desired to have an electric drive system with the high efficiency without gear losses while maintaining acceptable weight and cost.

### SUMMARY

The present invention relates generally to electric vehicles and more particularly to electric motor drive system and corresponding control systems.

In a first aspect, an electric vehicle may comprise a vehicle chassis extending between a front and a rear and having a steering axle coupled to the vehicle chassis and arranged near the front of the vehicle chassis. The electric vehicle may further comprise a first drive axle coupled to the vehicle chassis and arranged near the rear of the vehicle chassis and a second drive axle coupled to the vehicle chassis and arranged near the rear of the vehicle chassis. The first drive axle may comprise a first axle housing, a first drive wheel rotatably supported by the first axle housing, and a first electric machine operably coupled to the first drive wheel through a first power path, the first power path including a first gear reduction. The second drive axle may comprise a second axle housing, a second drive wheel rotatably supported by the second axle housing, and a second electric machine operably coupled to the second drive wheel through a second power path, the second power path having no speed change.

In another aspect, an electric vehicle may comprise a vehicle chassis extending between a front and a rear and having a steering axle coupled to the vehicle chassis and arranged near the front of the vehicle chassis. The electric vehicle may further comprise a drive axle coupled to the vehicle chassis and arranged near the rear of the vehicle chassis. The drive axle may comprise an axle housing and a drive wheel rotatably supported by the axle housing. The drive axle may further comprise a first electric machine operably coupled to the drive wheel through a first power path, the first power path including a first gear reduction, and a second electric machine operably coupled to the drive wheel through a second power path, the second power path having no speed change.

In yet another aspect, an electric vehicle may comprise a vehicle chassis extending between a front and a rear and having a steering axle coupled to the vehicle chassis and arranged near the front of the vehicle chassis. The electric vehicle may further comprise a first drive axle coupled to the vehicle chassis and a second drive axle coupled to the vehicle chassis. The first drive axle may comprise a first axle housing, a first drive wheel rotatably supported by the first axle housing, a first electric machine operably coupled to the first drive wheel through a first power path, the first power path including a first gear reduction, and a disconnect clutch operably coupled to the first drive wheel and the first electric machine and arranged in the first power path therebetween, wherein actuation of the clutch disconnects the first drive wheel from the first electric machine. The second drive axle may comprise a second axle housing, a second drive wheel rotatably supported by the second axle housing, and a second electric machine operably coupled to the second drive wheel through a second power path, the second power path having no speed change. The electric vehicle may further comprise a drivetrain controller in electrical communication with the first electric machine, the second electric machine, and the disconnect clutch, wherein the drivetrain controller is configured to vary a relative power output of the first electric machine and the second electric machine and to control actuation of the disconnect clutch.

Any of the above aspects can be combined in full or in part. Any features of the above aspects can be combined in full or in part. Any of the above implementations for any aspect can be combined with any other aspect. Any of the above implementations can be combined with any other implementation whether for the same aspect or a different aspect.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is a rear perspective view of a heavy-duty vehicle having a body supported on a chassis, and an electric drivetrain system including a front steering axle, a first drive axle, and a second drive axle.

FIG. 2 is a first exemplary layout of the electric drivetrain system on a 6×4 vehicle, shown schematically.

FIG. 3 is a second exemplary layout of an electric drivetrain system on a 6×4 vehicle, shown schematically.

FIG. 4 is a schematic diagram of a drive axle with a 2-speed gear reduction and a disconnect clutch.

FIG. 5 is a graph of overall drive system efficiency from an inverter to a wheel end as a function of the designed wheel end torque distribution ratio factor.

FIG. 6 is a third exemplary layout of an electric drivetrain system on a 4×2 vehicle, shown schematically.

FIG. 7 is a schematic diagram of a drive axle, such as shown in FIG. 6.

FIG. 8 is a fourth exemplary layout of an electric drivetrain system on a 4×4 vehicle, shown schematically.

FIG. 9 is a fifth exemplary layout of an electric drivetrain system on a 4×4 vehicle utilizing hub motors, shown schematically.

FIG. 10 is a schematic diagram of a drive axle, such as shown in FIGS. 6 and 7.

FIG. 11 is a schematic diagram of a control architecture for an electric axle, such as shown in FIGS. 6 and 7.

### DETAILED DESCRIPTION

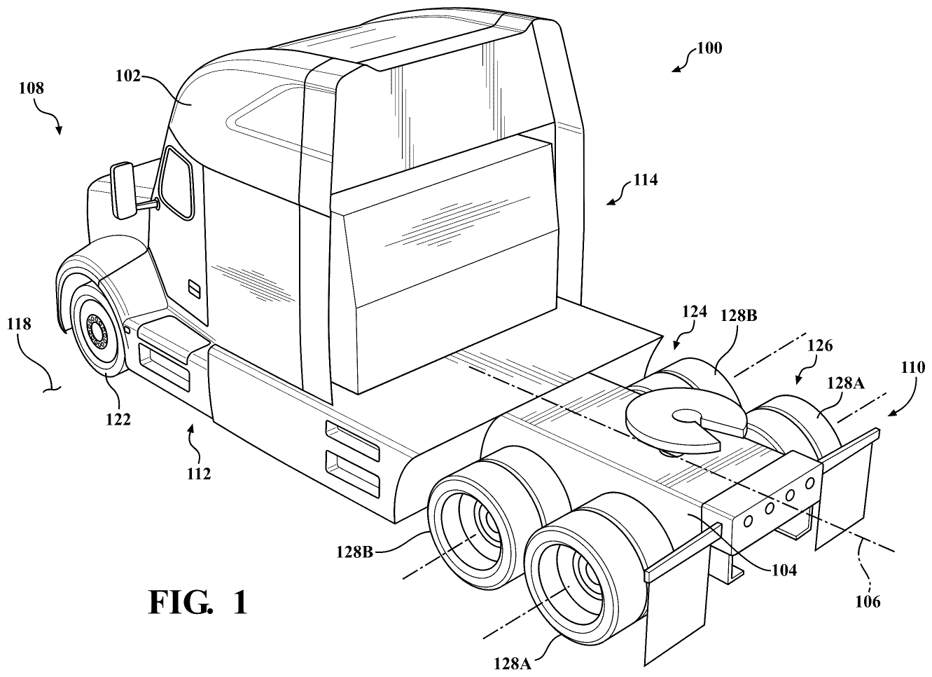

FIG. 1 shows a heavy-duty vehicle 100 used for transporting heavy and/or large cargo. The exemplary heavy-duty vehicle 100 illustrated here is shown as a tractor unit, such as a Class 8 semi-truck configured for towing a semi-trailer (not shown). The heavy-duty vehicle 100 may take other forms such as a straight truck (e.g., a dump truck) or a bare chassis, such as may be used for a mobile crane. The heavy-duty vehicle generally comprises a body 102, which may include a cab with controls usable by an operator to drive the heavy-duty vehicle 100. The body 102 may further comprise a sleeper with living quarters for the operator. Other implementations of the body may include cargo carrying equipment such as an enclosed cargo box, a dump box, or wrecker equipment (e.g., a wheel lift or flatbed). The heavy-duty vehicle 100 further comprises a chassis 104 supporting the body 102. The chassis 104 extends along a vehicle centerline 106 from a front end 108 to a rear end 110, according to the primary direction of travel of the heavy-duty vehicle 100. The centerline 106 further defines a left side 112 and a right side 114 of the chassis 104.

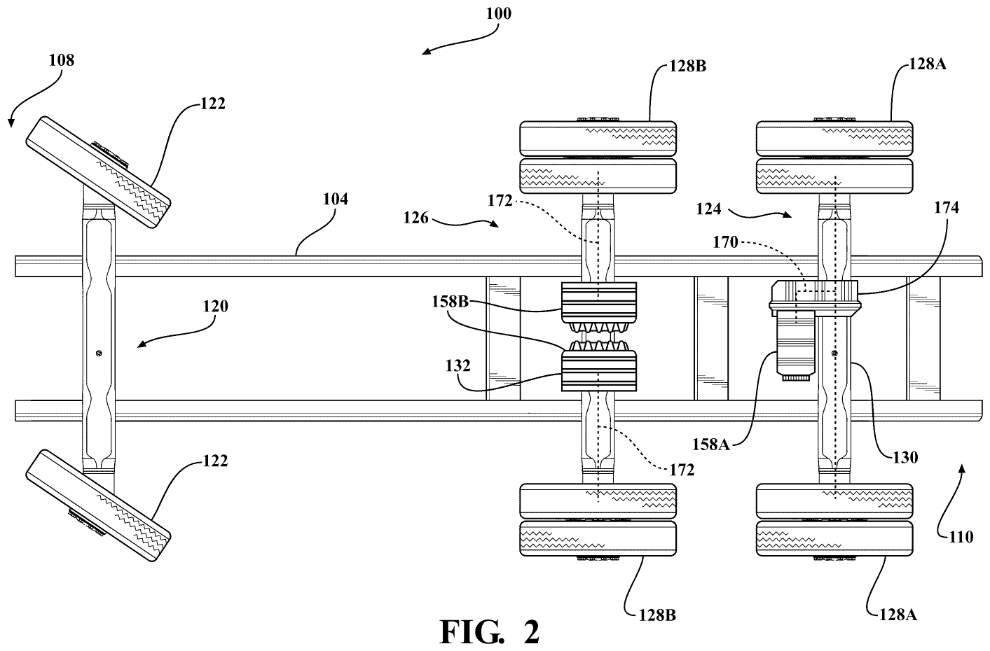

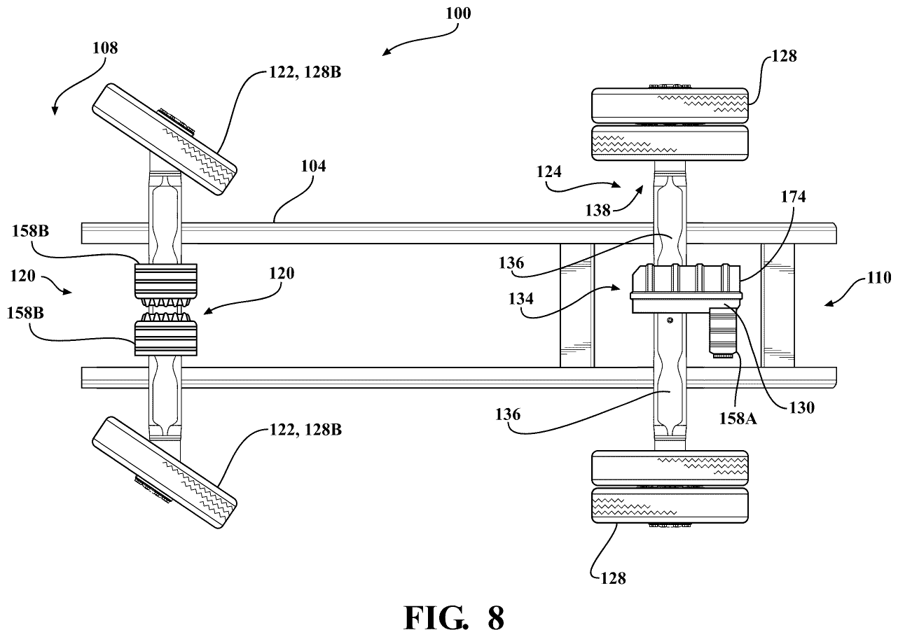

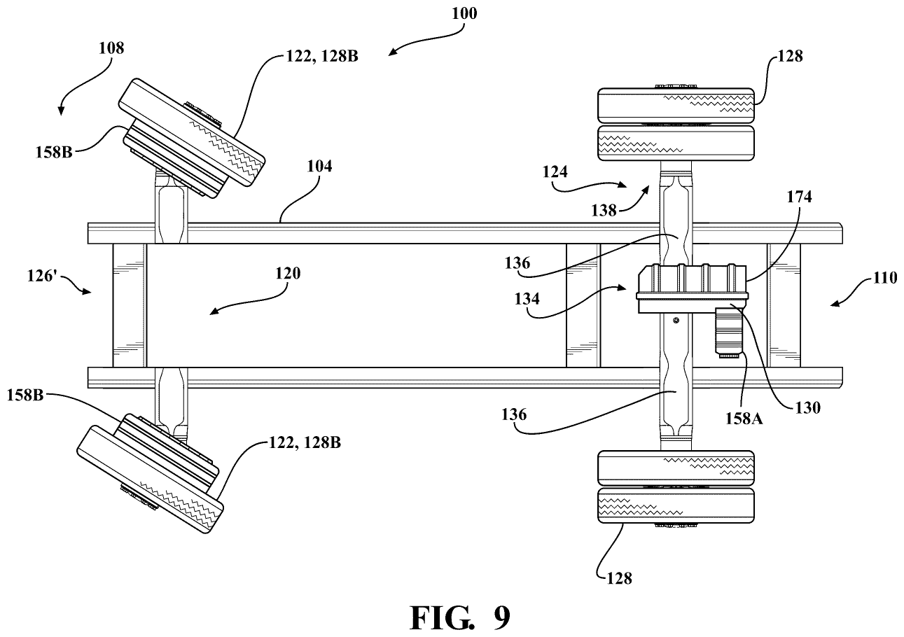

The heavy-duty vehicle 100 may further comprise a driveline system 116 to facilitate locomotion of the heavy-duty vehicle 100 along a ground surface such as a roadway 118 or other surfaces. The driveline system 116 illustrated here may comprise a steering axle 120 arranged near the front end 108 and coupled to the chassis 104. The steering axle 120 is generally perpendicular to the centerline 106 and extends from the left side 112 to the right side 114. The steering axle 120 may comprise a steer wheel, with one steer wheel 122 arranged on each of the left and right sides 112, 114. The steer wheels 122 are configured for pivoting movement about a kingpin relative to the centerline 106. In some implementations the driveline system 116 may comprise more than one steering axle, each having a pair of steer wheels. In a first exemplary implementation of the steering axle 120, illustrated in FIGS. 2, 3 and 6, the steer wheel 122 is non-driven (i.e., the steer wheels 122 cannot propel the heavy-duty vehicle 100). Said differently, the steer axle 120 is free from an electric machine coupled to the steer wheel in such a way as to provide for locomotion of the heavy-duty vehicle 100. It is appreciated that while the steer axle 120 may be unpowered, or free from an electric machine, other functions of the steering axle 120 that require power may utilize an electric machine. For example, the steering axle 120 may be equipped with a power-steering system comprising an electric motor. This electric motor may be arranged to transmit force to a wheel hub or knuckle (not shown) to pivot the steer wheel 122 about the kingpin. Other such systems may include hydraulic or pneumatic power assisted steering, or to power other functions such as a height or track adjustable suspension, braking, and similar. However other implementations of the heavy-duty vehicle 100 may utilize a powered steering axle such as off-road vehicles. Several such implementations of a heavy-duty vehicle 100 utilizing a powered steering axle are shown in FIGS. 8 and 9.

Illustrated schematically in FIG. 2, the driveline system 116 may further comprise a first drive axle 124 and a second drive axle 126 arranged near the rear end 110 of the heavy-duty vehicle 100 and coupled to the chassis 104 in a tandem configuration. Similar to the steering axle 120, the first drive axle 124 and the second drive axle 126 are each generally perpendicular to the centerline 106 and extend from the left side 112 to the right side 114. Each drive axle comprises a wheel 128 arranged on each opposing end of the drive axle on the left side 112 and the right side 114. More specifically, the first drive axle 124 comprises a first wheel(s) 128A and the second drive axle 126 comprises a second wheel(s) 128B. The wheels 128 shown here are illustrated as a “dual” wheel, which includes a pair of wheels coupled together and facilitate an increased load-carrying capacity of the heavy-duty vehicle 100. The dual wheels further contribute to increased reliability through redundancy in case of a deflated or otherwise damaged tire. The wheels 128 may also be single wheels having an extra wide configuration, colloquially known as a “super-single”.

As shown in FIG. 2, the first and second drive axles 124, 126 are powered axles comprising electric machines (discussed below) for propelling the heavy-duty vehicle 100 along a roadway. The exemplary driveline system 116 as configured with powered first and second drive axles 124, 126 and an unpowered steering axle is commonly referred to as a 6×4 configuration, for six total wheels and four driven wheels. The heavy-duty vehicle 100 is a fully electric vehicle, with each of the drive axles 124, 126 utilizing exclusively electric machines that are not mechanically coupled to an internal combustion engine. As mentioned above, the heavy-duty vehicle 100 may be equipped with a powered steering axle (not shown), which would result in a driveline system with a 6×6 configuration.

Here, the first and second drive axles 124, 126 of the heavy-duty electric vehicle 100 may have a different configuration from each other. However, each of the first and second drive axles 124, 126 have similar components serving similar functions. As such, components that are structurally similar between each of the first drive axle 124 and the second drive axle 126 are identified with the same reference number, and with individual elements appended with A, B, C, and D, as appropriate, for respective first, second, third, and fourth iterations included with the same heavy-duty vehicle 100. More specifically, when referring to individual components and their arrangement or configuration relative to each other the reference numbers are appended with A, B, C, and D as appropriate (e.g., first wheel 128A, second wheel 128B), and when referring to the components collectively the reference number is used without a letter (e.g., wheels 128). As such, in FIGS. 1 and 2, the first drive axle 124 and second drive axle 126 are shown with the first wheel(s) 128A coupled to the first drive axle 124 and the second wheel(s) 128B coupled to the second drive axle 126. Furthermore, each of the first drive axle 124 and the second drive axle 126 comprises an axle housing. The first drive axle 124 comprises a first axle housing 130 and the second drive axle 126 comprises a second axle housing 132.

It should be appreciated that the instantaneous power requirements of the heavy-duty vehicle 100 can vary by a large degree and depend on many external factors. For example, the power required for launch (i.e., accelerate from a stop) and grading (i.e., climbing a hill) is much greater than the power required to maintain a steady-state speed on a level roadway. Additionally, these conditions are more greatly affected by the weight of the heavy-duty vehicle 100 and the cargo than steady-state operation. Said differently, the power required to accelerate from a stop when the heavy-duty vehicle 100 is fully loaded is much greater than the power required to accelerate from a stop when the heavy-duty vehicle 100 is unladen, whereas the power required to maintain a steady-state speed is comparatively unaffected by the weight of the cargo. Specifically, aerodynamic drag is the largest contributor to the power required to maintain a steady-state speed and overall weight is the largest contributor to the power required for launch and grading.

With the above considerations in mind, it will be appreciated that during operation of the heavy-duty vehicle 100, situations in which it is necessary to use the full power of the heavy-duty vehicle 100 are infrequent relative to the situations where only a fraction of that power is being used. Furthermore, the operating conditions of the heavy-duty vehicle 100 in some of these situations are more suited for a first drive axle 124 and a second drive axle 126 having a different configuration. Specifically, and as will be described in further detail below, the increased power potential of the first drive axle 124 is best suited for launch and grading, whereas the greater overall efficiency of the second drive axle 126 is best suited for steady state operation.

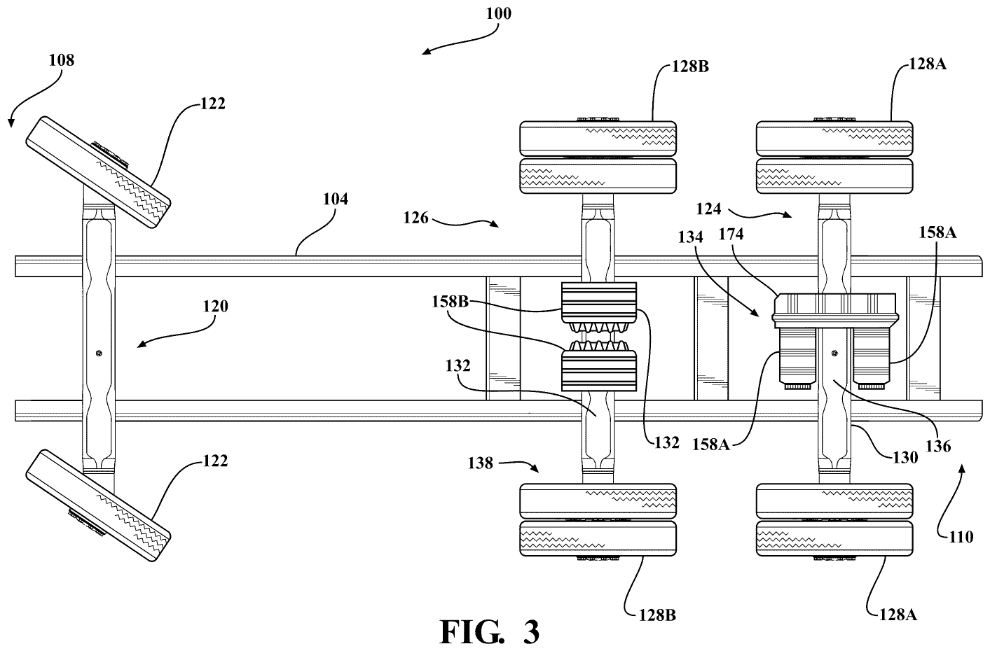

Looking to FIGS. 2 and 3, the drive axles 124, 126 are shown without the chassis 104. As mentioned above, the drive axles 124, 126 comprise the axle housing 130, which comprises a center section 134, two axle tubes 136 protruding from opposing sides of the center section 134, and wheel ends 138 arranged at a distal end of each axle tube 136. Each wheel end 138 may comprise brakes for slowing and stopping the heavy-duty vehicle 100. The brakes may be implemented as drum brakes or disc brakes. The disc brakes may comprise calipers and actuators coupled to the axle housing 130, and rotors coupled to the wheels 128. Each of the wheel ends 138 may further comprise a hub assembly rotatably supported on the axle tubes 136 by bearings.

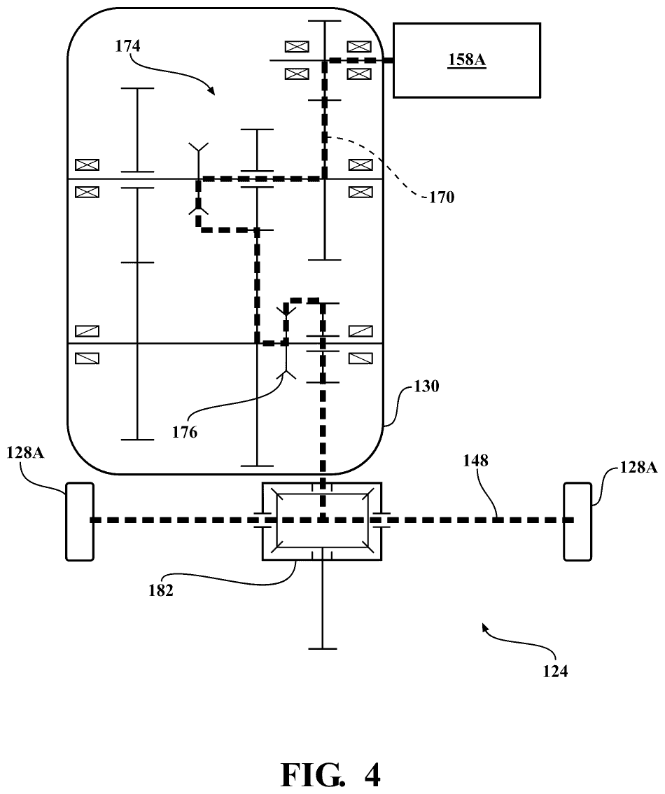

Turning to FIG. 4, the first drive axle 124 as shown in FIG. 2, is depicted schematically as comprising two axle shafts 148 disposed in the axle tubes 136 and extending between the center section 134 and the wheel ends 138. The hub assemblies are coupled to the wheels 128 and to the axle shafts 148 for transferring torque therebetween. Each of the axle shafts comprises a spline end and a flange end. The spline end is arranged in the center section 134 and configured for engagement with the carrier assembly and the flange end is arranged at the wheel end 138 and configured for engagement with the hub assembly.

Each of the drive axles 124, 126 further comprises an electric machine 158 operably coupled to the respective wheel 128. For example, in FIG. 2, a first electric machine 158A of the first drive axle 124 is operably coupled to the first wheel(s) 128A rotatably supported on the first axle housing 130. Similarly, a second electric machine 158B is operably coupled to one of the second wheel(s) 128B rotatably supported on the second axle housing 132. Most generally, the electric machines 158 are capable of converting energy between electrical energy and mechanical energy, and more particularly rotational mechanical energy. One such electrical machine is a motor/generator. When operating as a motor, electrical energy supplied to the electric machines 158 is converted to rotational mechanical energy for propelling the heavy-duty vehicle 100. Conversely, when operating as a generator, rotational mechanical energy from the heavy-duty vehicle 100 (i.e., when the vehicle is moving) may be converted into electrical energy and recharge an on-board battery. Other operating conditions are contemplated, such as supplying electrical energy to the electric machine 158 for braking, which resists rotation beyond what might normally be capable by operating the electric machine 158 as a generator.

Referring again to FIG. 4, the first drive axle 124 may comprise a first electric machine 158 operably coupled to the first wheel 128A through a first power path 170. The first power path 170 is the series of mechanical interfaces along which torque and rotation (i.e., power) are transferred between the first electric machine 158 and the first wheel 128A. Here, the first power path 170 of the first drive axle 124 begins at an output interface of the first electric machine 158A and comprises a gear reduction 174 and a first axle shaft 148 coupled to the first wheel 128A at the end of the first power path 170. Here too, the gear reduction 174 is implemented as a shiftable multi-ratio (i.e., two-speed) gear reduction. One of the ratios being better suited for launching the heavy-duty vehicle 100 from a stop, while the other ratio being better suited for additional power while the vehicle is already at a desired roadway speed (e.g., climbing a hill or overtaking traffic).

In the implementation described herein, the first electric machine 158A and the second electric machine 158B may be the same type of electric machines. The first electric machine 158A and the second electric machine 158B may both be permanent magnet motors or may both be induction motors. It should be appreciated that the designations such as first, second, left, and right are used to aid in describing the subject matter and are not limited as to the specific location or arrangement of the electric machines in the heavy-duty vehicle 100. Alternatively, the first electric machine 158A and the second electric machine 158B may be different types. Said differently, the first electric machine 158A may be an induction motor and the second electric machine 158B may be a permanent magnet motor. In some implementations axial flux motors may be utilized for the second electric machine 158B. Other implementations may utilize radial flux motors having sufficient continuous torque and efficiency at low rpm to sustain roadway speeds of the heavy-duty vehicle 100.

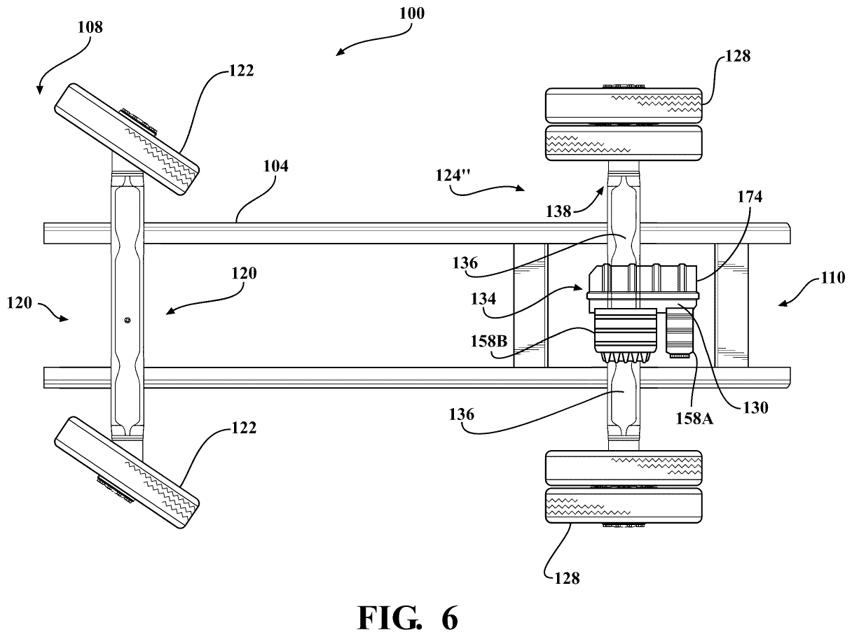

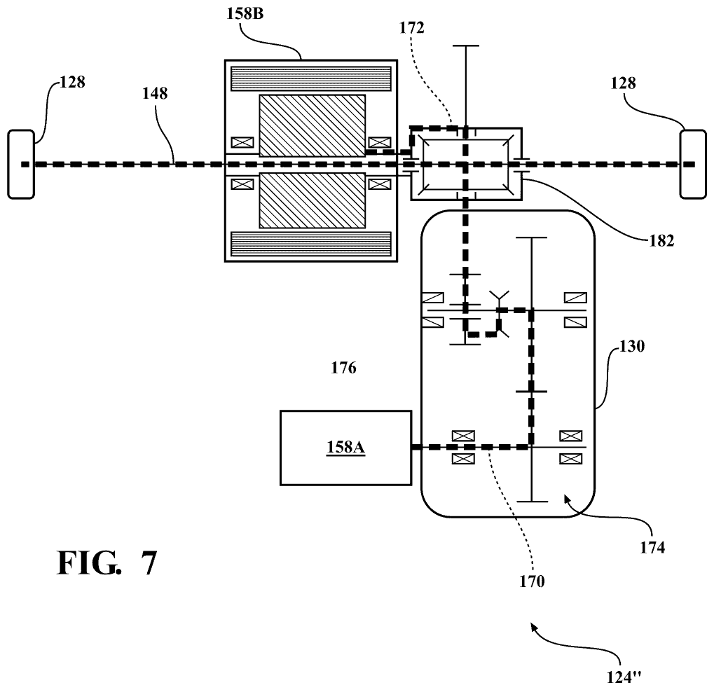

Most generally, the heavy-duty vehicle 100 is propelled by at least two electric machines 158, which are operably coupled to the wheels 128 through a power path, and the heavy-duty vehicle 100 has two different power paths. A first power path 170 includes a speed change, typically a gear reduction, which reduces the relative rotational speed of the first electric machine 158A and the first wheel 128A. Said differently, the ratio of rotational speed of the first electric machine 158A and the rotational speed of the first wheel 128A is increased (e.g., a 10:1 reduction, in which rotational speed of the electric machine is reduced by a factor of 10). A second power path 172 is a direct drive power path, in which there is no speed change. Said differently, the rotational speed of the second electric machine 158B and the rotational speed of the second wheel 128B are the same (i.e., a 1:1 ratio). It will be appreciated that the absolute rotational speed of each of the electric machines 158 will vary during operation as the heavy-duty vehicle 100 accelerates and decelerates according to conditions and factors (e.g., local speed limits). However, as used herein, speed change refers to relative speed between a driven wheel and the associated electric machine. Some implementations of the heavy-duty vehicle 100 utilize drive axles 124, 126 that have only one power path per axle. Discussed in greater detail below, other implementations of the heavy-duty vehicle 100 may utilize a drive axle 124′ with two power paths on the same axle, such as shown in FIGS. 6-7.

As described above, the heavy-duty vehicle 100 may utilize the first power path 170 having the gear reduction 174 as a supplemental or “boost” power path, while the second power path 172 with no speed change may be utilized to increase vehicle efficiency. The first power path 170 provides additional torque and/or power for demanding operation conditions, for example hard acceleration or grade climbing conditions. With the first power path 170, the first electric machine 158A can be designed and sized to prioritize torque, power, and cost for a given application (e.g., size and weight carrying capacity), because the first electric machine 158A is intended for only intermittent operation. Comparatively, the second electric machine 158B using the second power path 172 can be designed and sized to meet the power demands of cruising on a relatively flat roadway. Because the second electric machine 158B is operably coupled to the second wheel 128B without a speed change, losses through a gear reduction are avoided, which increases efficiency.

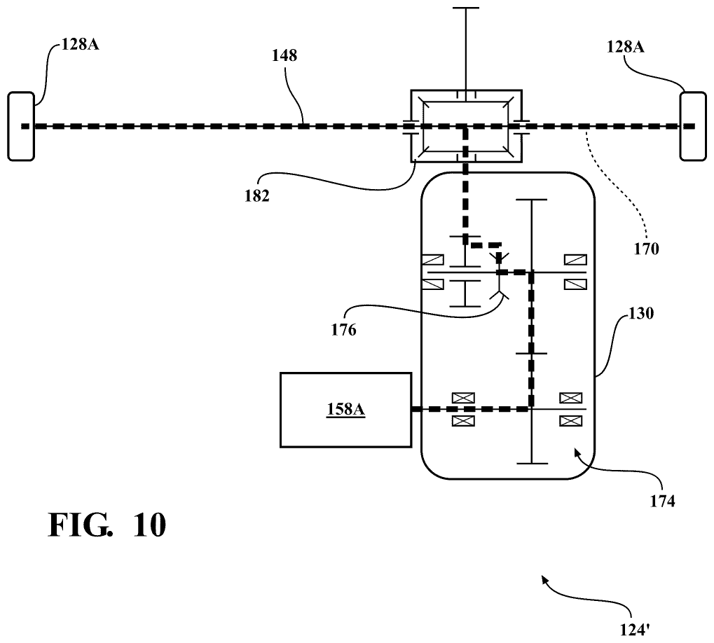

Some implementations of the first drive axle 124 may further comprise a disconnect clutch 176 operably coupled to the first wheel 128A and the first electric machine 158A and arranged in the first power path 170 therebetween. One such example of this configuration is shown in FIGS. 4 and 10. The disconnect clutch 176 is configured for controllable actuation by a drivetrain controller 232 to disconnect the first wheel 128A from the first electric machine 158A. Said differently, the disconnect clutch interrupts the first power path 170 to prevent rotation and torque from being transferred. In this way the first wheel 128A is free to spin without also spinning the first electric machine 158A and the gear reduction 174, which may reduce losses due to friction or oil stirring, thereby increasing efficiency. The disconnect clutch 176 may be actuated electronically, hydraulically, or pneumatically and may be capable of partial engagement and/or disengagement (such as a friction clutch). The disconnect clutch 176 may be utilized to provide a smooth engagement of the first drive axle 124 when transition from an unpowered state to a powered state. For example, if the drivetrain controller 232 detects that additional power is needed from the first drive axle 124, the previously disengaged first electric machine 158A can be operated to match the rotational speed on both an input and output side of the disconnect clutch 176 prior to actuating the disconnect clutch 176 to enable power to be transferred between the first electric machine 158A and the first wheel 128A.

As mentioned above, the first power path 170 and the second power path 172 may be packaged separately on the first drive axle 124 and the second drive axle 126, or may be combined on the same drive axle, such as shown in FIG. 6. Here, the disconnect clutch 176 is actuated to engage or disengage the gear reduction 174 of the first power path 170 with the direct drive of the second power path 172.

Alternatively, the either of the first power path 170 and the second power path 172 may be implemented with each utilizing two or more electric machines 158A, 158B, with or without a mechanical differential. FIG. 3 shows an exemplary configuration on a 6×4 vehicle. Here, the first axle 124 comprises a pair of first electric machines 158A each connected to the first wheels 128A. Likewise, the second axle 126 comprises a pair of second electric machines 158B, with each connected to one of the second wheels 128B. More specifically, the pair of second electric machines 158B is a left second electric machine and a right second electric machine, each coupled to a corresponding left second wheel and right second wheel.

The second drive axle 126 may utilize one or more second electric machines 158B that are specified to fulfill the continuous power and torque requirements of the respective heavy-duty vehicle's weight and class during cruising conditions with no grade (i.e., flat). The second electric machines 158B drive the second wheels 128B and are of sufficient capability so as to maintain the speed of the heavy-duty vehicle 100 during zero grade operating conditions without engaging the first electric machine 158A on the first drive axle 124. The second drive axle 126 may, in some instances, utilize a differential and may further comprise clutches to lock the rotation of the left and right wheels together under low traction conditions to provide the heavy-duty vehicle 100 with additional starting ability. The first drive axle 124 may utilize one or more first electric machines 158A with a single speed gear reduction (FIG. 10) or a multi-speed gear reduction (FIG. 4), both of which may include a disconnect clutch 176. The first drive axle 124 is further configured to provide sufficient launching, accelerating, and grading (i.e., hill climbing) capability in conjunction with the second drive axle 126 when extra torque and power should be needed.

The continuous torque and the continuous power for the second power path 172 of the second drive axle 126 may be determined according to the following equations.

$${T}_{dd} = {f}_{dd} * ( {F}_{rr} + {F}_{aero} ) * {r}_{tire}$$

$${P}_{dd} = {T}_{dd} * {v}_{veh} / ( 3.6 * 2 {r}_{tire} )$$

T_{dd}=max continuous wheel end torque desired to size the second electric machine(s) 158B.

f_{dd}=designed wheel end torque distribution ratio factor for the second power path 172.

Fᵣᵣ=tire rolling resistance force.

Fₐₑᵣₒ=aerodynamic drag force.

rₜᵢᵣₑ=rolling radius of the second wheel 128B.

P_{dd}=max continuous wheel end power desired to size the second electric machine(s) 158B.

vᵥₑₕ=vehicle speed in km/h.

Ideally, f_{dd}, the factor to determine continuous torque of the second electric machine(s) 158B, should be set at ≈1.25 to provide excess capacity for headwind or mild grades without the necessitating frequent engagement of the first drive axle 124. However, the value of f_{dd} could be range from 0.5 to well above 1.0 depending on the particular vehicle application, available packaging space, and the vehicle weight.

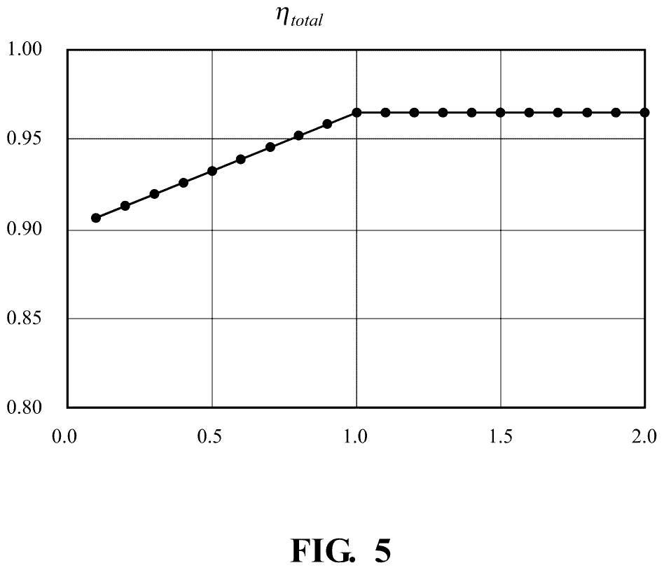

FIG. 5 shows the overall drive system efficiency from an inverter to wheel end as a function of f_{dd}, assuming a loaded 80,000-pound class 8 truck, cruising at 60 mph on flat road with wheel end power demand about 160 kW. The second power path 172 has an efficiency of 96.5%, and the first power path 170 has an efficiency of 90%. At lower speeds, the benefits of the direct-drive connection between the second electric motor 158B and the second wheel 128B of the second power path could be even greater. The overall power flow may be reduced due to further reductions in electromagnetic drag, windage, oil splashing/stirring, and bearing losses.

Size and selection of the electric machines 158A utilized in the first power path 170 are determined so as to meet the full performance requirements for a vehicle under normal operating conditions. The normal operating conditions include, for example, the gradeability, 0-60 mph acceleration time in conjunction with the contributions from the electric machines 158B of the second power path. More specifically, the first electric machine 158A torque and power, quantity of available gear ratios (i.e., speeds), and gear ratios, are defined based on the desired vehicle characteristics and the performance benchmarks of the second drive axle 126 and the second power path 172.

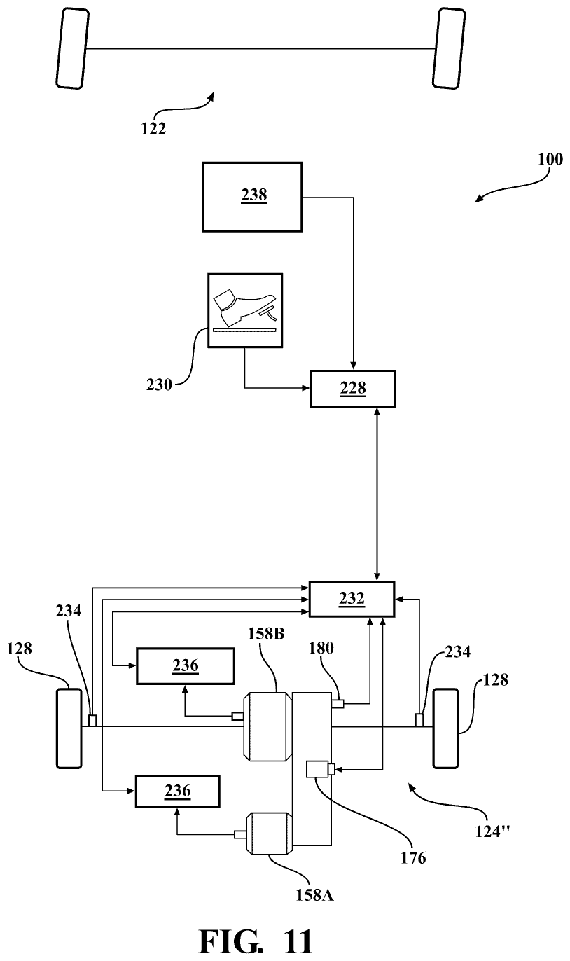

Referring to FIG. 11, the heavy-duty vehicle 100 may further comprise a drivetrain controller 232 in electrical communication with the first electric machine 158A and the second electric machine 158B. Some implementations of the heavy-duty vehicle 100 may further utilize a vehicle control unit 228, which may receive signals from various vehicle sensors. The vehicle control unit 228 is in electrical communication with the drivetrain controller 232. In other implementations the drivetrain controller 232 and the vehicle control unit 228 may be integrated into a single device. The drivetrain controller 232 utilizes inputs from vehicle sensors to determine operating characteristics of the heavy-duty vehicle 100. For example, the drivetrain controller 232 receives a driver demand control from a throttle pedal 230 operated by a driver to determine a desired acceleration of the heavy-duty vehicle 100 as well as the grade of the road and the traffic speed for upcoming roads. With these data, the drivetrain controller 232 may also predict a desired acceleration for upcoming roads or grades. From the desired and/or predicted acceleration, the drivetrain controller 232 determines an operating point of the first and second electric machines 158A, 158B, and sends a control signal to a motor controller or inverter 236, which converts the control signal to a high-voltage signal, which is supplied to each electric machine 158A, 158B. The drivetrain controller 232 may be further configured to control actuation of the disconnect clutch 176 for directing operation as described above. Specifically, using the predicted acceleration, the drivetrain controller 232 may actuate the disconnect clutch 176 prior to a driver's demanded acceleration to both improve efficiency as well as to make operation of the heavy-duty vehicle more comfortable.

In addition to a sensor in the throttle pedal 230 for determining the driver demand, other vehicle sensors are utilized to determine operating characteristics of the heavy-duty vehicle 100. The drivetrain controller 232 may receive input signals from other sensors on the heavy-duty vehicle 100 such as a yaw sensor, a steering sensor, a throttle pedal 230 position sensor, and a brake pedal position sensor. These signals indicate vehicle status such as a turning rate, a desired turning radius, and a desired vehicle speed.

The heavy-duty vehicle 100 may further comprise a grade sensor 180 coupled to the chassis 104 and in communication with the drivetrain controller 232. The grade sensor 180 is configured to provide an output signal corresponding to a grade value (i.e., angle) of the roadway (or off-road) surface on which the heavy-duty vehicle is traveling. The grade value, typically represented as a percentage, is the slope of the particular surface the heavy-duty vehicle 100 may be climbing, and is proportional to the amount of power necessary to maintain a desired speed. In some implementations the grade sensor 180 may be implemented as an accelerometer configured to generate an output signal proportional to a gravity vector. Additionally or alternatively, the grade sensor may utilize a GPS receiver 238 to determine the location of the heavy-duty vehicle 100 and look up the grade value of that location in a database.

Wheel speed sensors 234 may be implemented on each of the drive axles 124, 126 and in electrical communication with the drivetrain controller 232 to facilitate a traction control system for the heavy-duty vehicle 100. In some implementations of the heavy-duty vehicle 100 the vehicle control unit 228 may further implement a stability control protocol utilizing signals from the wheel speed sensors 234. For example, a virtual differential can replicate a limited-slip or locking differential if wheel slip is detected by the wheel speed sensors 234, the power supplied to one of the electric machines 158 can be reduced and/or sent to another electric machine 158 in order to maximize the tractive forces while accelerating. In this way, the virtual differential can reduce the effects of a loss of traction, which may lead to a loss of vehicle control, or the heavy-duty vehicle 100 becoming stuck on low friction surfaces.

The drivetrain controller 232 is configured to operate each of the first drive axle 124 and the second drive axle 126 to maximize the efficiency of the heavy-duty vehicle 100. The drivetrain controller 232 can be operated in one or more modes. For example, the heavy-duty vehicle 100 may utilize one or more of the following modes: (1) a flat road and cruising mode in which only the second drive axle 126 and the second power path 172 are operated to propel the heavy-duty vehicle 100 while the first drive axle 124 is in a decoupled state with the disconnect clutch disengaging the first electric machine 158A from the first wheel 128A. The mode will offer the best overall efficiency; (2) a high demand mode in which both the first drive axle 124 and the second drive axle 126 are operated to provide the heavy-duty vehicle 100 sufficient torque and power for accelerating, launching, or grading. In the high demand mode, the drivetrain controller 232 may further be configured to vary the relative power output of the first electric machine 158A and the second electric machine 158B based on an output signal from the grade sensor 180. The drivetrain controller 232 is capable of varying the power distribution between the first power path 170 and the second power path 172 from 0-100% based upon the application and the optimal efficiency points of the power paths 170, 172 as determined by a powertrain loss minimization governing algorithm. The drivetrain controller 232 can operate the first and second electric machines 158A, 158B such that 100% of the available power is sent to either of the first electric machine 158A or the second electric machine 158B (e.g., the first electric machine 158A receives 100% of the available power and the second electric machine 158B receives 0% of the available power), or other operating points in between (e.g., the first electric machine 158A receives 25% of the available power and the second electric machine 158B receives 75% of the available power). Said differently, each of the first electric machine 158A and the second electric machine 158B can operate separately from each other and supply up to 100% of the available power.

Certain implementations of the second drive axle 126, such as shown in FIG. 2, 3, 7, or 8, may utilize a second drive axle 126 having a pair of second electrical machines 158B. Here, the pair of second electrical machines 158B is further defined as left and right second electrical machines 158B, wherein the left electrical machine and the right electrical machine are not operably coupled to each other and are rotationally independent. While each of the left and right second electrical machines 158B are both coupled to and supported by the second axle housing 132, there is no power path therebetween, and therefore mechanical power is not transferred. Because there is no power path between a left wheel and a right wheel 128B operably coupled to one of the associated left and right second electric machines 158B, the second drive axle 126 may comprise a virtual differential, implemented through software controls, which operates each of the wheels 128 on the second drive axle 126 at a different speed in response to steering inputs of the heavy-duty vehicle 100. Additionally, the first drive axle 124 and the second drive axle 126 may be electrically linked with a second virtual differential, which controls the second drive axle 126 to rotate at a different speed than the first drive axle 124.

Known methods of differentiating rotational speed between each of the axle shafts include a differential, which uses a series of gears arranged in an interconnected manner to simultaneously drive both axle shafts at different speeds. Differentials are particularly useful for vehicle drive axles because, as the vehicle is turning, one wheel travels a greater distance than the other, and therefore must rotate faster. In the present implementation, the aforementioned virtual differential commands the electric machines 158 to operate as different speeds as the heavy-duty vehicle 100 is turning.

For light duty four-wheel vehicles, the electric drive systems may be realized with different layouts. Several example drivetrain system layouts are shown in FIGS. 6-10. In FIG. 6, a drive axle 124″ having both the first electric machine 158A and the second electric machine 158B coupled to the same axle housing is shown. In FIG. 8, an exemplary second drive axle 126 configuration is shown on the front of the vehicle. The second drive axle 126 in FIG. 8 may utilize a virtual differential on the front axle.

Further still, by utilizing a greater number of electric machines 158, each motor of the heavy-duty vehicle 100 may be smaller. When a greater number of motors are utilized, it is possible to more closely match the most efficient operating point of the electric machines 158 to the requirements of the vehicle. More specifically, a single motor capable of providing enough power to accelerate a fully loaded vehicle will not operate at peak efficiency when the heavy-duty vehicle 100 is driving at a steady-state speed. Conversely, a smaller motor can be operated at its peak efficiency to maintain a steady-state speed of the heavy-duty vehicle 100, and additional motors can provide additional power only when necessary.

In the exemplary implementation of a drive axle, shown in FIGS. 2 and 3, the first electric machine(s) 158A is arranged on the first drive axle 124, and the second electric machine(s) 158B is arranged on the second drive axle 126. Furthermore, the first drive axle 124 is shown arranged as a trailing drive axle and the second drive axle is shown as a leading drive axle. The first drive axle 124 may be arranged more toward the front end 108 of the heavy-duty vehicle 100 than the second drive axle 126, while still adjacent to the second drive axle 126. Likewise, the second drive axle 126 may be arranged more toward the rear end 110 of the heavy-duty vehicle 100 than the first drive axle 124. Said differently, the first drive axle 124 may be arranged on the centerline 106 of the heavy-duty vehicle 100 between the steering axle 120 and the second drive axle 126. In some implementations the first drive axle 124 and the second drive axle 126 could be arranged differently, such as with the second drive axle 126 as the leading drive axle and the first drive axle 124 as the trailing drive axle.

As mentioned above, in another exemplary implementation of a drive axle 124″, shown in FIG. 6, the first electric machine(s) 158A and the second electric machine(s) 158B are arranged on the same drive axle 124″. Here, the first power path and the second power path both include the same wheel 128. It is further contemplated that a heavy-duty vehicle 100 could be fitted with two of the drive axle 124″ of this implementation. A first of the drive axle 124″ could be arranged as a trailing drive axle and the second of the drive axle 124″ could be implemented as a leading drive axle. The leading drive axle may be arranged more toward the front end 108 of the heavy-duty vehicle 100 than the trailing drive axle.

In FIG. 7, the drive axle 124″ of FIG. 6 is shown schematically. Here, the drive axle 124″ may comprise a mechanical differential coupled to each of the wheels 128. Similar to the first drive axle 124 described above, the first power path 170 may comprise a gear reduction 174 with a disconnect clutch 176 to decouple the first electric machine 158A and gear reduction 174 from the wheels 128. The disconnect clutch 176 decouples the first electric machine 158A a majority of the components of the gear reduction 174 to minimize losses due to oil stirring, motor electromagnetic drag, and motor windage.

In FIGS. 8 and 9 the second drive axle 126 is shown arranged at the front 108 of the heavy-duty vehicle 100. More specifically, in these implementations the second drive axle 126 is a steering axle, giving the vehicle a 4×4 configuration. In FIG. 8, the second drive axle 126 may be a solid beam-type axle with the second electric machines 158B supported in the second axle housing 132. In FIG. 9, the second drive axle 126″ is implemented with each of the second electric machines 158B as hub motors, such as may be used in a vehicle having independent front suspension.

In FIG. 10, an alternative drive axle 124′ is shown schematically. Here, the drive axle 124′ may comprise a mechanical differential 182 operably coupled to each of the wheels 128. Similar to the first drive axle 124 described above, the first power path 170 may comprise a gear reduction 174 with the disconnect clutch 176 to decouple the first electric machine 158A and gear reduction 174 from the wheels 128. The disconnect clutch 176 decouples the first electric machine 158A a majority of the components of the gear reduction 174 to minimize losses due to oil stirring, motor electromagnetic drag, and motor windage. The second electric machine 158B associated with the second power path 172 is coupled directly to the mechanical differential 182 to power the wheels 128 with minimal losses. The first electric machine 158A associated with the first power path 170 is coupled to the gear reduction 174, which may include a disconnect clutch 176. The gear reduction 174 can be disconnected to decouple the first power path 170 and associated first electric machine 158A from the wheels 128 to reduce losses and increase efficiency.

Several instances have been discussed in the foregoing description. However, the aspects discussed herein are not intended to be exhaustive or limit the disclosure to any particular form. Various modifications to these aspects will be readily apparent to those skilled in the art, and the generic principles defined herein may be applied to other aspects without departing from the scope of the disclosure. The terminology that has been used is intended to be in the nature of words of description rather than of limitation. Many modifications and variations are possible in light of the above teachings and the disclosure may be practiced otherwise than as specifically described.

1. An electric vehicle comprising:
a vehicle chassis extending between a front and a rear;
a steering axle coupled to the vehicle chassis and arranged near the front of the vehicle chassis;
a first drive axle coupled to the vehicle chassis and arranged near the rear of the vehicle chassis, the first drive axle comprising;
a first axle housing;
a first drive wheel rotatably supported by the first axle housing;
a first electric machine operably coupled to the first drive wheel through a first power path, the first power path including a first gear reduction;
a second drive axle coupled to the vehicle chassis and arranged near the rear of the vehicle chassis, the second drive axle comprising;
a second axle housing;
a second drive wheel rotatably supported by the second axle housing; and
a second electric machine operably coupled to the second drive wheel through a second power path, the second power path having no speed change.

2. The electric vehicle of claim 1, wherein the steering axle includes a non-driven wheel, the steering axle is free of an electric machine coupled to the non-driven wheel, and the second drive axle is arranged between the first drive axle and the steering axle.

3. (canceled)

4. The electric vehicle of claim 1, wherein the first drive wheel is further defined as a pair of first drive wheels, and the first drive axle further comprises a differential operably coupled to the pair of first drive wheels and the first electric machine and arranged in the first power path therebetween.

5. The electric vehicle of claim 1, wherein the second drive wheel is further defined as a left drive wheel and a right drive wheel, and the second electric machine is further defined as a left electric machine and a right electric machine, wherein the left electric machine is coupled to the left drive wheel and the right electric machine is coupled to the right drive wheel.

6. The electric vehicle of claim 5, wherein the left electric machine and the right electric machine are not operably coupled and are rotationally independent of each other.

7. The electric vehicle of claim 1, wherein the second electric machine is further defined as an axial flux electric machine.

8. The electric vehicle of claim 1, wherein the first drive wheel is further defined as a left drive wheel and a right drive wheel, and the first electric machine is further defined as a left electric machine and a right electric machine.

9. The electric vehicle of claim 1, further comprising a drivetrain controller in electrical communication with the first electric machine and the second electric machine wherein the drivetrain controller is configured to vary a relative power output of the first electric machine and the second electric machine.

10. (canceled)

11. The electric vehicle of claim 9, wherein the drivetrain controller is further configured to control actuation of a disconnect clutch based on the relative power output of the first electric machine and the second electric machine.

12. The electric vehicle of claim 9, wherein the drivetrain controller is configured to vary the relative power output of the first electric machine and the second electric machine based on a grade value of a surface on which the electric vehicle is traveling and the drivetrain controller is further configured to actuate a disconnect clutch based on the grade value of the surface on which the electric vehicle is traveling.

13. The electric vehicle of claim 12, further comprising a grade sensor in communication with the drivetrain controller configured to provide an output signal corresponding to the grade value of the surface on which the electric vehicle is traveling, wherein the drivetrain controller is configured to vary the relative power output of the first electric machine and the second electric machine based on the output signal from the grade sensor.

14. (canceled)

15. An electric vehicle comprising:
a vehicle chassis extending between a front and a rear;
a steering axle coupled to the vehicle chassis and arranged near the front of the vehicle chassis;
a drive axle coupled to the vehicle chassis and arranged near the rear of the vehicle chassis, the drive axle comprising;
an axle housing;
a drive wheel rotatably supported by the axle housing;
a first electric machine operably coupled to the drive wheel through a first power path, the first power path including a first gear reduction; and
a second electric machine operably coupled to the drive wheel through a second power path, the second power path having no speed change.

16. The electric vehicle of claim 15, wherein the steering axle includes a non-driven wheel, and the steering axle is free of an electric machine coupled to the non-driven wheel.

17. The electric vehicle of claim 15, wherein the drive axle is further defined as a leading drive axle, and further comprising a trailing drive axle arranged near the rear of the vehicle chassis, the trailing drive axle comprising;
a trailing axle housing;
a trailing drive wheel rotatably supported by the trailing axle housing; and
a trailing first electric machine operably coupled to the trailing drive wheel through a trailing first power path, the trailing first power path including a trailing first gear reduction;
a trailing second electric machine electric machine operably coupled to the trailing drive wheel through a trailing second power path, the trailing second power path having no speed change.

18. The electric vehicle of claim 15, further comprising a drivetrain controller in electrical communication with the first electric machine and the second electric machine wherein the drivetrain controller is configured to vary a relative power output of the first electric machine and the second electric machine.

19. (canceled)

20. The electric vehicle of claim 17, wherein a drivetrain controller is further configured to control actuation of a disconnect clutch based on a relative power output of the first electric machine and the second electric machine.

21. The electric vehicle of claim 20, wherein the drivetrain controller is configured to vary the relative power output of the first electric machine and the second electric machine based on a grade value of the surface on which the electric vehicle is traveling.

22. The electric vehicle of claim 21, further comprising a grade sensor in communication with the drivetrain controller configured to provide an output signal corresponding to the grade value of the surface on which the electric vehicle is traveling, wherein the drivetrain controller is configured to vary the relative power output of the first electric machine and the second electric machine based on the output signal from the grade sensor.

23. The electric vehicle of claim 21, wherein the drivetrain controller is further configured to actuate the disconnect clutch based on the grade value of the surface on which the electric vehicle is traveling.

24. An electric vehicle comprising:
a vehicle chassis extending between a front and a rear;
a first drive axle coupled to the vehicle chassis, the first drive axle comprising;
a first axle housing;
a first drive wheel rotatably supported by the first axle housing;
a first electric machine operably coupled to the first drive wheel through a first power path, the first power path including a first gear reduction;
a disconnect clutch operably coupled to the first drive wheel and the first electric machine and arranged in the first power path therebetween, wherein actuation of the disconnect clutch disconnects the first drive wheel from the first electric machine;
a second drive axle coupled to the vehicle chassis, the second drive axle comprising;
a second axle housing;
a second drive wheel rotatably supported by the second axle housing;
a second electric machine electric machine operably coupled to the second drive wheel through a second power path, the second power path having no speed change; and
a drivetrain controller in electrical communication with the first electric machine, the second electric machine, and the disconnect clutch, wherein the drivetrain controller is configured to vary a relative power output of the first electric machine and the second electric machine and to control actuation of the disconnect clutch.

25. (canceled)

26. (canceled)

27. (canceled)

28. (canceled)

29. (canceled)

30. (canceled)

31. (canceled)
